(19) United States
(12) Patent Application Publication
(10) Pub. No.: US 2003/0139092 A1
(43) Pub. Date: Jul. 24, 2003

(54) Synchronous conductive wire insertion device for lamp rod and wire connecting seat

(76) Inventor: Wen-Chang Wu, Taipei (TW)

Correspondence Address: Wen-Chang Wu, 235 Chung - Ho, Box 8-24, Taipei, TW

(21) Appl. No.: 10/054,466

(22) Filed: Jan. 24, 2002

(51) Int. Cl. H01R 13/73

(52) U.S. Cl. 439/551

(57) ABSTRACT

A synchronous conductive wire insertion device for a lamp rod and a wire connecting seat comprises a retaining seat and a locking seat. The retaining seat has stepped through hole. A larger stepped hole of the through hole is exactly inserted by a female joint of a first electric wire. A male joint of a second electric wire is exactly positioned in a bottom stepped hole of the inserting hole. After the locking seat inserts into the retaining seat from a top end thereof, the male joint slightly protruded from a bottom end of the locking seat has an end portion which is exactly inserted into the female joint. The user only inserts the locking seat into the retaining seat without using any locking tool. Thus, the user may assemble it by himself or herself.

### BACKGROUND OF THE INVENTION

1. Field of the Invention

The present invention relates to wire connection device of lamps, and particularly to a synchronous conductive wire insertion device for a lamp rod and a wire connecting seat. The user only inserts a lamp rod into the retaining seat of a wire connecting box without using any locking tool. Thus, the user can assemble the wire connecting box by himself or herself.

2. Description of Related Art

Prior wire connection devices of lamps, such as wall lamps, stand type lamps, ceiling lamps, use studs and nuts to lock the components. In assembly, not only the user is easy to be harmed, but also other locking tools (such as spanners, openers, etc.) are necessary. Moreover, in assembly, electric wires are easy to expose out and some dangers are induced. Thereby, the prior art is not suitable to be assembled by the user. In general, the manufacturer assembles the device in advance, namely, the wire box is assembled with inserting rods in the manufacturing process. However, a large space is required for transferring and storing the wire connection device and thus cost is increased.

### SUMMARY OF THE INVENTION

Accordingly, the primary object of the present invention is to provide a synchronous conductive wire insertion device for a lamp rod and a wire connecting seat. The synchronous conductive wire insertion device comprises a retaining seat, and a locking seat. The retaining seat has stepped through hole. A larger stepped hole of the through hole is exactly inserted by a female joint of a first electric wire. A male joint of a second electric wire is exactly positioned in a bottom stepped hole of the inserting hole. After the locking seat inserts into the retaining seat from a top end thereof, the male joint slightly protruded from a bottom end of the locking seat has an end portion which is exactly inserted into the female joint in the retaining seat; as a result, the first and second electric wire are conducted.

Another object of the present invention is to provide a synchronous conductive wire insertion device for a lamp rod and a wire connecting seat, wherein the locking seat and the lamp rod are capable of being pulled from the retaining seat for reducing the necessary space. Since the retaining seat is assembled to the wire connecting box, the user only inserts the locking seat into the retaining seat. Then, it can be used without using any locking tool; thus, the user may assemble it by himself or herself.

The various objects and advantages of the present invention will be more readily understood from the following detailed description when read in conjunction with the appended drawing.

### BRIEF DESCRIPTION OF THE DRAWINGS

FIG. 1 is an exploded perspective view of the present invention.

FIG. 1A shows another embodiment of the present invention.

FIG. 2 shows an assembled view of the present invention.

FIG. 3A is a plane cross section view of the present invention before the lamp rod is inserted.

FIG. 3B is a plane cross section view of the present invention after the lamp rod is inserted.

### DETAILED DESCRIPTION OF THE PREFERRED EMBODIMENTS

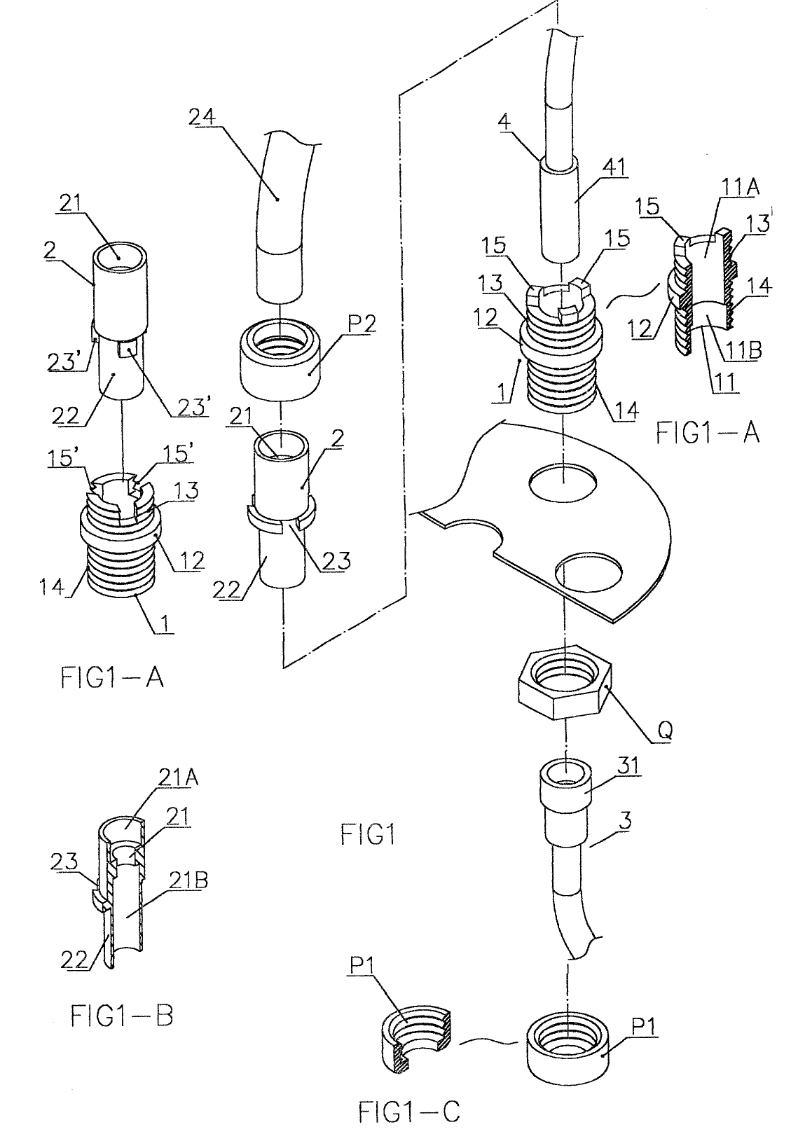

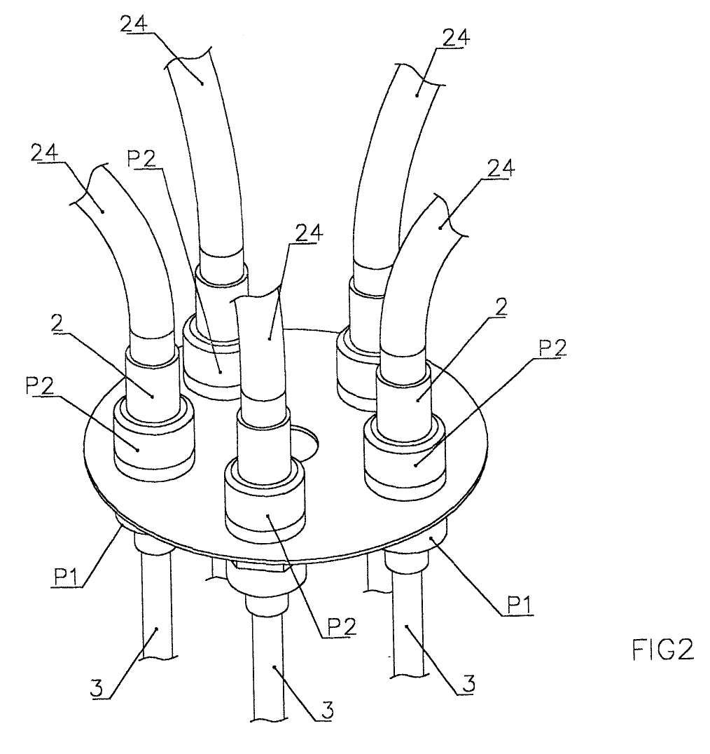

Referring to FIGS. 1, 1A and 2, the synchronous conductive wire insertion device for a lamp rod and a wire connecting seat of the present invention is illustrated. The synchronous conductive wire insertion device includes a retaining seat 1 installed in a bottom plate D1 of a wire connecting box D, and a locking seat 2 inserted in a retaining seat 1. The retaining seat 1 has a stepped through hole 11. Thereby, the locking seat 2 is exactly inserted into a smaller stepped hole 11A of the through hole 11 and then positioned therein. The larger stepped hole 11B of the through hole 11 is exactly inserted by a female joint 31 of an electric wire 3. An outer side of the retaining seat 1 is protruded with a flange 12. Two sides of the flange 12 are a front threaded section 13 and a rear threaded section 14. Thereby, after the retaining seat 1 is inserted into the top end of the wire connecting box D. The bottom plate D1 of the wire connecting box D is locked with a confining nut Q. Thereby, the retaining seat 1 is positioned to the wire connecting box D. A top edge of the retaining seat 1 is protruded with two buckles 15 (or grooves 15′) for preventing the locking seat 2 from rotation. Furthermore, the rear threaded section 14 of the retaining seat 1 is locked to a confining ring P1. The electric wire 3 passes through the confining ring P1. A lower end of the confining ring P1 exactly supports the female joint 31 of the electric wire 3 for preventing the electric wire 3 from falling down.

An interior of the locking seat 2 has a two-staged stepped inserting hole 21. Thereby, an electric wire 4 is exactly inserted from a lower end of the locking seat 2 and then the male joint 41 of the electric wire 4 is exactly positioned in a bottom stepped hole 21B of the inserting hole 21. An end portion of the male joint slightly protrudes from a bottom end 22 of the locking seat 2. After the locking seat 2 inserts into the retaining seat 1 from a top end thereof. The male joint 41 slightly protrudes from a bottom end of the locking seat 2 and has an end portion which is exactly inserted into the female joint 31 in the retaining seat 1. As a result, the wire is conducted. The parts of the annular surface of the locking seat 2 is engaged with the buckles 15 (or grooves 15) of the retaining seat 1 are installed with grooves 23 (or blocks 23′) for preventing the locking seat 2 from rotation. After the locking seat 2 is inserted into the retaining seat 1, a confining ring P2 is placed around the upper part of the locking seat 2. The confining ring P2 is exactly locked to the front threaded section 13 of the retaining seat 1. Thereby, the locking seat 2 is positioned to the retaining seat 1.

Moreover, in the top stepped hole 21A of the locking seat 2, a hollow lamp rod 24 is welded therein. The lamp rod 24 can be passed through by the electric wire 4.

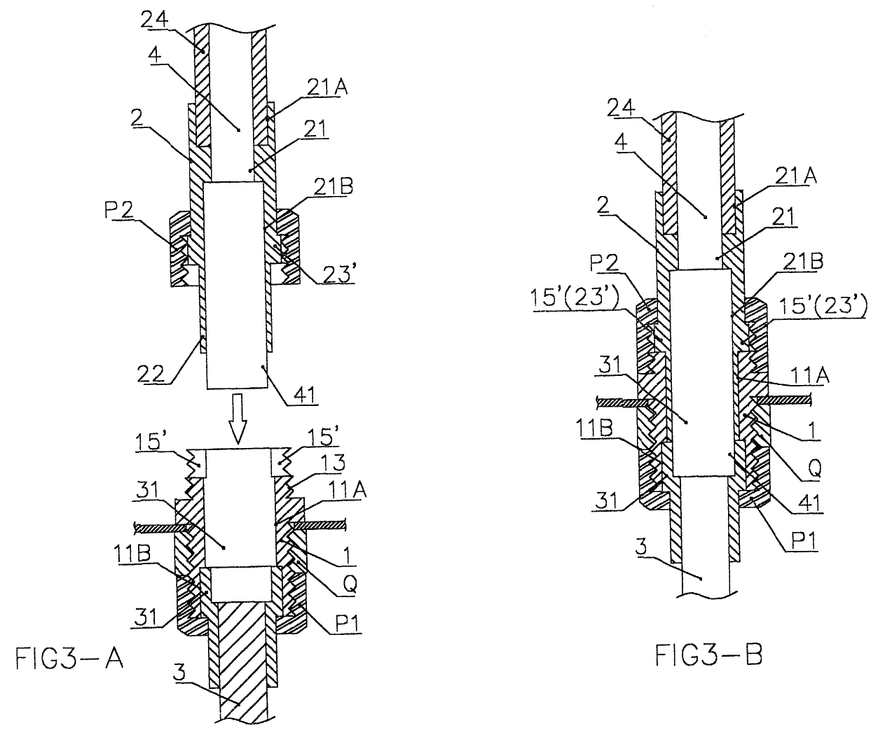

The assembly of the present invention will be described hereinafter. Referring to FIG. 3, after the electric wire 3 is inserted into the retaining seat 1, it is locked to the wire connecting box D by the confining nut Q so that the female joint 31 of the electric wire 3 exactly protrudes to the larger stepped hole 11B of the retaining seat 1. The electric wire 4 is inserted into the locking seat 2 from a lower end thereof in advance. The male Joint 41 of the electric wire 4 protrudes to the bottom end of the locking seat 2. Thereby, when the locking seat 2 is inserted into the retaining seat 1 by the confining ring P1 thereof. Then the top of the locking seat 2 is welded with the lamp rod 24. Thereby, when the locking seat 2 is inserted into the retaining seat 1, the lower end 22 of the locking seat 2 is exactly inserted into the smaller stepped hole 11A of the retaining seat 1, and the female joint 31 protruding from the lower end of the locking seat 2 is exactly engaged with the male joint 41 positioned in the larger stepped hole 11B. Thereby, the retaining seat 1 and the locking seat 2 are conductive. Thereby, the confining ring P1 is tightly locked so that the locking seat 2 is positioned above the retaining seat 1. When it is desired to take down the locking seat 2 from the retaining seat 1, it is only necessary to loose the confining ring P1, and then the locking seat 2 may be taken out from the retaining seat 1.

Thereby, when it is desired to package, transfer, or store the lamp seat, the locking seat 2 and the lamp rod 24 can be pulled from the retaining seat 1 for reducing the necessary space. Moreover, since the retaining seat 1 is assembled to the wire connecting box D. the user only inserts the locking seat 2 into the retaining seat 1. Then, it can be used without using any locking tool. Thus, the user may assemble it by himself or herself.

Although the present invention has been described with reference to the preferred embodiments, it will be understood that the invention is not limited to the details described thereof. Various substitutions and modifications have been suggested in the foregoing description, and others will occur to those of ordinary skill in the art. Therefore, all such substitutions and modifications are intended to be embraced within the scope of the invention as defined in the appended claims.

What is claimed is:

1. A synchronous conductive wire insertion device for a lamp rod and a wire connecting seat; the synchronous conductive device comprising a retaining seat installed to a bottom plate of a wire connecting box, and a locking seat inserted to a retaining seat; characterized in that the retaining seat has a through hole; a larger stepped hole of the through hole is exactly inserted by a female joint of a first electric wire; an outer surface of the retaining seat has a front threaded section and a rear threaded section; the bottom plate of the wire connecting box is locked with a confining nut; thereby, the retaining seat is positioned to the wire connecting box; the rear threaded section of the retaining seat is locked to a first confining ring; the first electric wire passes through the first confining ring; a lower end of the first confining ring exactly supports a female joint of the first electric wire for preventing the first electric wire from falling down;
an interior of the locking seat has a two-staged stepped inserting hole; an top stepped hole of the inserting hole is welded with a lamp rod; and a male joint of a second electric wire is exactly positioned in a bottom stepped hole of the inserting hole; an end portion of the male joint slightly protrudes from a bottom end of the locking seat; wherein after the locking seat inserts into the retaining seat from a top end thereof; the male joint slightly protruded from a bottom end of the locking seat has an end portion which is exactly inserted into the female joint in the retaining seat; as a result, the first and second electric wire are conducted; after the locking seat is inserted into the retaining seat, a second confining ring is placed around an upper part of the locking seat; the second confining ring is exactly locked to the front threaded section of the retaining seat; thereby, the locking seat is positioned to the retaining seat; after the second confining ring is released, then the locking seat can be taken out from the retaining seat;
wherein the locking seat and the lamp rod are capable of being pulled from the retaining seat for reducing the necessary space; since the retaining seat is assembled to the wire connecting box; the user only inserts the locking seat into the retaining seat; then, it can be used without using any locking tool; thus, the user may assemble it by himself or herself.

2. The synchronous conductive wire insertion device for a lamp rod and a wire connecting seat as claim in claim 1, wherein a top edge of the retaining seat is protruded with two buckles, and an outer surface of the locking seat are formed with grooves which are engagable with the buckles of the top edge of the retaining seat so as to prevent the locking seat from rotation.
